(19) United States
(12) Patent Application Publication
(10) Pub. No.: US 2018/0330410 A1
(43) Pub. Date: Nov. 15, 2018

(54) OFFER-REVIEW MATCHING BASED ON UNIFORM RESOURCE LOCATOR CONTENT

(71) Applicant: Google Inc., Mountain View, CA (US)

(72) Inventors: Yuk Wah Wong, Pittsburgh, PA (US); Natalie Sandrine Glance, Pittsburgh, PA (US)

(73) Assignee: Google Inc., Mountain View, CA (US)

(21) Appl. No.: 14/174,842

(22) Filed: Feb. 6, 2014

(51) Int. Cl. G06Q 30/02

(52) U.S. Cl. CPC G06Q 30/0282

(57) ABSTRACT

A review matching system receives Uniform Resource Locators (URLs) that are associated with product reviews for one or more products of a particular merchant. The review matching system also receives URLs associated with offers for one or more products of the merchant. After receiving the URLs, the review matching system determines the content of the product-review URLs and the product-offer URLs. Based on the determined content of the URLs, the review matching system determines a content of the product-review URL that matches content of the offer URL. If the review matching system determines a content match, the review matching system determines that the product-review URL is associated with the offer URL. The review matching system thus determines that the product review is a review for the product associated with the product-review URL.

### TECHNICAL FIELD

The present disclosure relates generally to matching product reviews to a product, and more particularly to matching product reviews to a product based on the content of Uniform Resource Locators (URLs) associated with both the product reviews and the offers for the products.

### BACKGROUND

When a user purchases a product, the user may provide an online review of the product. For example, if the user purchased the product through the merchant's website, the user may—by accessing review links associated with the merchant's website—input comments regarding the product. For example, the user may indicate whether the product met the user's expectations. A system responsible for managing product reviews for the merchant may then associate the user's review with the reviewed product, such as via a link on the merchant's website. Other users can then access the product review when evaluating the product.

Although this product review process may be sufficient for product reviews that are associated with a specific merchant's website, it does not work well when a merchant seeks to provide product offers—and the associated product reviews for the offers—on a third-party's website. For example, the merchant may provide product-offer URLs to the third-party, whereas the system responsible for managing product reviews for the merchant may separately provide product-review URLs to the third-party. Hence, the third-party often receives product-offer URLs and product-review URLs, without being able to correlate the reviews to the correct products of the merchant. The third-party is thus limited in its ability to provide product reviews for a particular product.

### SUMMARY

In certain example aspects described herein, a computer-implemented method for matching reviews to products is provided. A review matching system, for example, receives a first Uniform Resource Locator (URL) of a merchant, the first URL being associated with a product review of a user. The review matching system also receives a second URL that is associated with an offer for a product of the merchant. By reading the content of the URL, for example, the review matching system determines a first content of the first URL and a second content of the second URL. The review matching system then identifies a content match between the first content of the first URL and the second content of the second URL. In response to identifying the content match, the review matching system determines that the product review associated with the first URL is a review of the product in the offer of the merchant associated with the second URL. The review matching system thus associates the product review with the product.

In certain other example aspects, a system for matching reviews to products is provided. Also provided in certain aspects is a computer program product for matching reviews to products.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for associating product reviews with offers for the product, in accordance with certain example embodiments.

FIG. 2 is a block flow diagram depicting a method 200 for associating a product review with an offer for the product of a merchant, in accordance with certain example embodiments

FIG. 3 is a block flow diagram depicting a method for receiving a product-review URL, in accordance with certain example embodiments.

FIG. 4 is a block diagram depicting a computing machine and a module, in accordance with certain example embodiments.

### DETAILED DESCRIPTION OF THE EXAMPLE EMBODIMENTS

### Overview

As disclosed herein, a review matching system receives URLs that are associated with product reviews for one or more products of a particular merchant. The review matching system also receives URLs associated with offers for one or more products of the merchant. The review matching system then determines the content of the product-review URLs and the offer URLs. Based on the determined content of the URLs, the review matching system determines a content of the product-review URL that matches content of the offer URL. If the review matching system determines a content match, the review matching system determines that the product-review URL is associated with the offer URL. The review matching system thus determines that the product review is a review for the product associated with the product-review URL.

More particularly, the review matching system receives a URL that is associated with an offer for a product. For example, a merchant offering a product for sale may create a link that—when input in to a web browser—directs a user to the offer for the product. The review matching system may receive the offer URL from any source, such as from a product offer feed from the merchant or from a website of the merchant. The offer URL may contain any type of information conventionally associated with a URL string, such as a sequence of letters, numbers, characters, or combinations thereof. The offer URL may also contain letters, numbers, characters, or combinations thereof that are unique to the URL and that relate to the product that is the subject of the offer associated with the offer URL. For example, an offer for a specific, fixed-gear bicycle from the particular merchant may include “bicyc2397_fgear” in the URL string. In certain examples, the offer URLs may contain multiple path components that are in a specific location within the URL strings.

In addition to receiving an offer URL that is associated with an offer for a particular product, the review matching system receives one or more product-review URLs. For example, the review matching system may receive a product review feed from an entity, such as a review management system, that manages product reviews for a particular merchant. Like the offer URL, the product-review URLs may contain any type of information conventionally associated with a URL string, such as a sequence of letters, numbers, characters, or combinations thereof. The product review URL may also contain certain embedded identifiers, such as a sequence of letters, numbers, characters, or combinations thereof that are unique to the product to which the associated review pertains. For example, a product-review URL associated with a review of the specific, fixed-gear bicycle noted above may contain—among additional information—the content “bicyc2397_fgear.” In certain examples, the embedded information may be specific to the merchant. For example, the identifier “bicyc2397_fgear” may only pertain to a specific merchant and not to other merchants. In certain examples, the product-review URL may contain multiple path components that are in a specific location within the URL strings.

After receiving an offer URL and one or more product-review URLs, the review matching system determines the content of the URLs. Based on the content of the URLs, the review matching system determines whether matching content exists among the product-review URLs and the offer URLs for the product. For example, the review matching system may determine, by reading the content of the URLs, that certain of the received product-review URLs and the received offer URL both contain the “bicyc2397_fgear” identifier as a content match. In certain examples, the review matching system may rely on merchant-specific extraction rules to extract and determine matching content among the product-review URLs and the offer URLs. For example, the review matching system may rely on co-occurrence statistics to identify and reinforce rules that lead to higher quality content matching for a particular merchant.

If the review matching system does not identify matching content among the product-review URLs and the offer URLs, the review matching system determines that the review associated with the product-review URL is not a review for the product associated with the offer URL. That is, the review matching system determines that the review associated with the product-review URL does not correspond to the product associated with the offer URL. But, if the review matching system identifies a match between the content of the product-review URL and the offer URL, then the review matching system determines that the review associated with the product-review URL is a review for the product associated with the offer URL. Hence, the review matching system associates the user's review with the product. For example, if both the product-review URL and the offer URL contain the “bicyc2397_fgear” identifier, then the review matching system determines that matching content exists among the product-review URL and the offer URL. Based on the matching content, the review matching system thus determines that the review associated with the product-review URL is a review for the product associated with the offer URL.

By matching content between product-review URLs and offer URLs from a merchant, the methods and systems described herein permit the association of multiple product reviews with the product that is the subject of the reviews. For example, by repeating the methods and systems described herein for different merchants, the review matching system can match several reviews to the same product, even though different merchants may offer the product. Hence, the methods and systems described herein enhance user experience by providing the user with an increased number of reviews for which to evaluate a product.

### Example System Architectures

Turning now to the drawings, in which like numerals indicate like (but not necessarily identical) elements throughout the figures, example embodiments are described in detail.

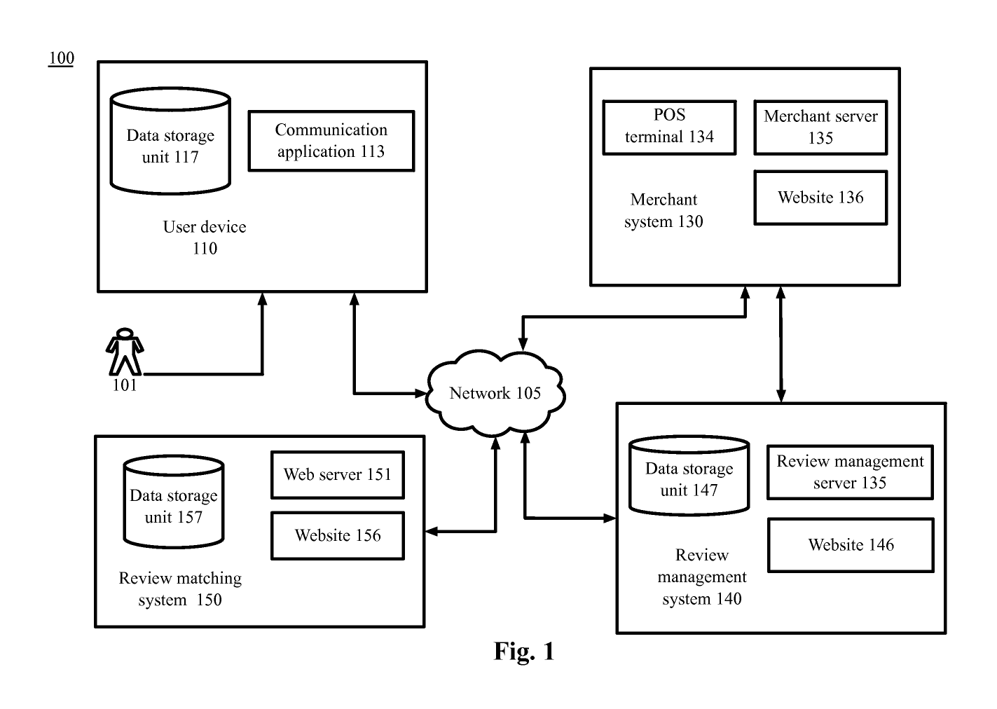

FIG. 1 is a block diagram depicting a system 100 for associating product reviews with offers for the product, in accordance with certain example embodiments.

As depicted in FIG. 1, the exemplary operating environment 100 includes a user network computing device 110, a merchant computing system 130, a review management computing system 140, and a review matching computing system 150 that communicate with each other via one or more networks 105. In another example embodiment, two or more of these computing systems (including systems 110, 130, 140, and 150) or parts thereof are integrated into the same system. In certain example embodiments, a user 101 associated with a user device 110 must install an application and/or make a feature selection on the user device 110 to obtain the benefits of the methods and techniques described herein.

Each network 105 includes a wired or wireless telecommunication means by which network devices (including devices 110, 130, 140, and 150) can exchange data. For example, each network 105 can include a local area network (“LAN”), a wide area network (“WAN”), an intranet, an Internet, a storage area network (SAN), a personal area network (PAN), a metropolitan area network (MAN), a wireless local area network (WLAN), a virtual private network (VPN), a cellular or other mobile communication network, Bluetooth, near field communication (NFC), or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 130, 140, and 150 includes a device having a communication module capable of transmitting and receiving data over the network 105. For example, each network device 110, 130, 140, and 150 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 130, 140, and 150 are operated by end-users or consumers, merchant system operators, and review management system 140 operators, and review matching system 150 operators.

The user 101 can employ a communication application 113, such as a web browser application 114 or a stand-alone application, to view, download, upload, or otherwise access documents or web pages via a distributed network 105. The communication application 113 of the user computing device 110 can interact with web servers or other computing devices connected to the network 105. For example, the communication application 113 can interact with the user network computing device 110, the merchant system 130, the review management system 140, and/or the review matching system 150. The communication application 113 may also comprise a web browser (not shown), which provides a user interface, for example, for accessing other devices associated with the network 105.

The user computing device 110 may also include a data storage unit 117. The example data storage unit 117 can include one or more tangible computer-readable storage devices. The data storage unit 117 can be a component of the user device 110 or be logically coupled to the user device 110. For example, the data storage unit 117 can include on-board flash memory and/or one or more removable memory cards or removable flash memory.

The merchant computing system 130 (or “merchant”) represents a system that offers products and/or services for the user 101 to purchase or use. In certain example embodiments, the merchant system 130 includes a point-of-sale (“POS”) terminal 134. The point-of-sale terminal 134 may be a physical location, for example, that is operated by a salesperson that enters purchase data into the point-of-sale terminal 134 to complete a purchase transaction. Affiliated or associated with the merchant system 130 is a merchant system operator (not shown). The merchant system operator, for example, may configure the merchant system 130 to provide offers for products.

The merchant computing system 130 may also comprise a merchant server 135, which in certain example embodiments may represent the computer-implemented system that the merchant system 130 employs to create and assemble a website 136 and content for the website 136, such as offers for products of the merchant system 130. In certain example embodiments, the website 136 provides a user interface for users 101 to purchase products online from the merchant system 130. In certain example embodiments, the website 136 may provide a user interface for the user to input product reviews in to the merchant system 130. In certain example embodiments, an operator (not shown) of the merchant system 130, for example, may configure the merchant system 130 to communicate product offers of one or more users to the review matching system 150. For example, the merchant system 130 may communicate URLs associated with product offers of the merchant system 130 to the review matching system 150 via the network 105.

The review management system 140 represents a system that, in certain example embodiments, manages reviews for the merchant system 130. For example, the review management system 140 may interact with the merchant system 130 via the network 105 to associate product reviews of the merchant's products with products that are the subject of the reviews. In certain example embodiments, the review management system 140 may execute and operate independently of the merchant system 130. Alternatively, the review management system 140 may execute and operate as part of the merchant system 130. The review management system 140 may also communicate with the merchant system 130 directly or indirectly via the network 105.

The review management system 140 may include a server, which represents the computer-implemented system for managing, receiving, and processing reviews for the merchant system 130. The review management system 140 may also include a website 146. The website 146, for example, may provide a user interface for the user 101 to provide a review of a product of the merchant system 130. In certain example embodiments, an operator (not shown) of the review management system 140, for example, may configure the review management system 140 to communicate product reviews of one or more users to the review matching system 150. For example, the review management system 140 may communicate URLs associated with product reviews for products of the merchant system 130 to the review matching system 150 via the network 105.

The review management system 140 may include an accessible data storage unit 147. For example, the data storage unit 147 may store received product review information of the multiple users 101. The exemplary data storage unit 147 can include one or more tangible computer-readable media. The data storage unit 147 can be stored on the user device 110 or can be logically coupled to the user device 110. For example, the data storage unit 147 can include on-board flash memory and/or one or more removable memory cards or removable flash memory.

The review matching system 150 represents a system for analyzing and determining content matches between received product-review URLs and offer URLs, so that product reviews for a product can be associated with the product, such as on a website 156 of the review matching system 150. The review matching system 150 can include a web sever 141, which may represent the computer-implemented system that the review matching system 150 employs to receive URLs, determine the content of the URLs, determine content matches among URLs, and associate a product review with the product that is the subject of the review.

The review matching system 150 may include an accessible data storage unit 157. For example, the data storage unit 157 may store content matches for received URLs as described herein. The exemplary data storage unit 157 can include one or more tangible computer-readable media. The data storage unit 157 can be stored on the user device 110 or can be logically coupled to the user device 110. For example, the data storage unit 157 can include on-board flash memory and/or one or more removable memory cards or removable flash memory.

It will be appreciated that the network connections shown are example and other means of establishing a communications link between the computers and devices can be used. Additionally, those having ordinary skill in the art and having the benefit of the present disclosure will appreciate that the user device 110, merchant system 130, the review management system 140, and the review matching system 150 in FIG. 1 can have any of several other suitable computer system configurations. For example, a user computing device 110 embodied as a mobile phone or handheld computer may not include all the components described above.

### Example Processes

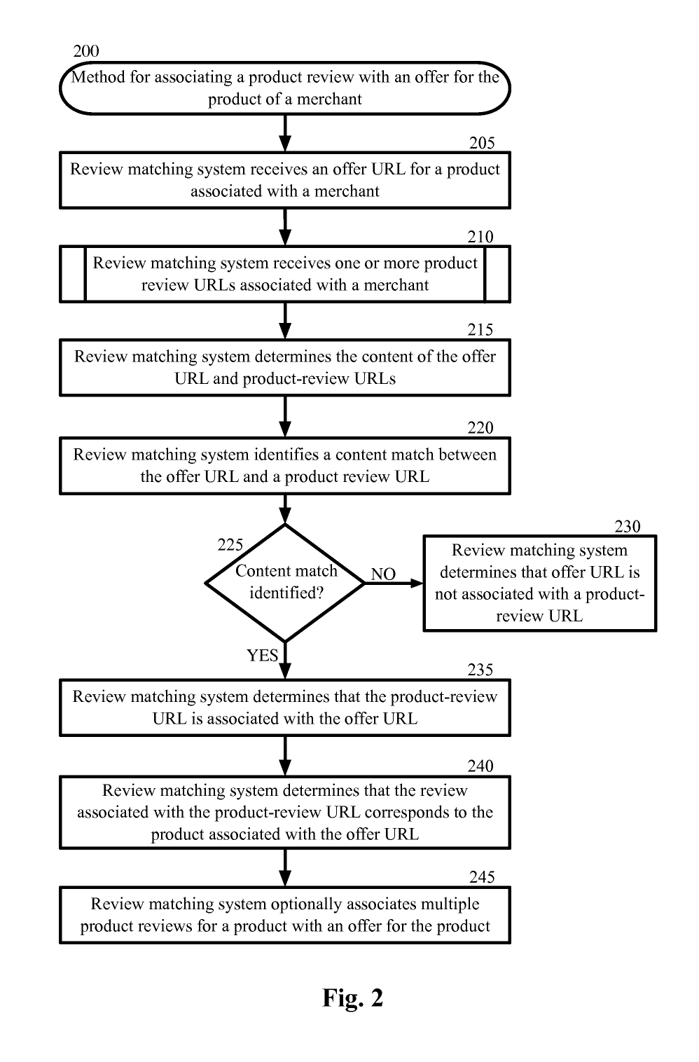

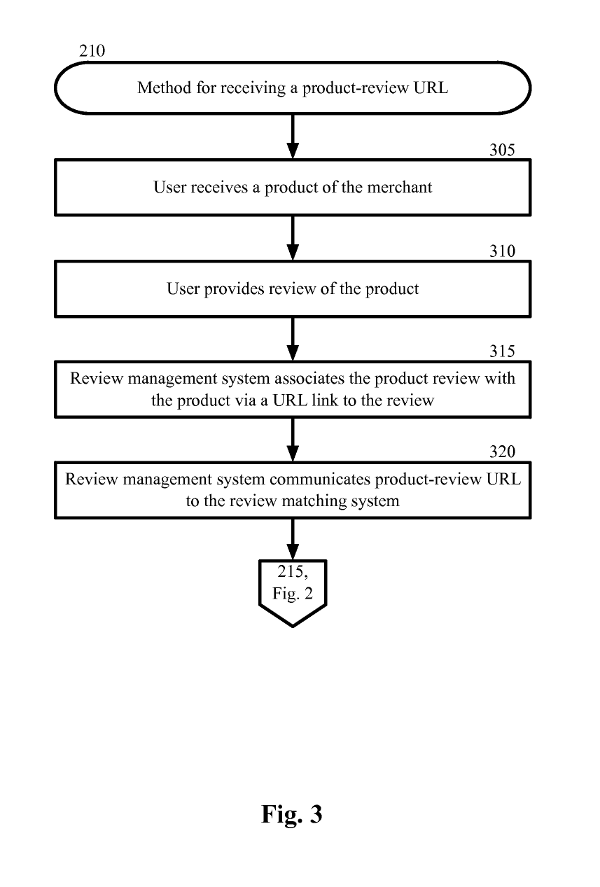

The components of the example operating environment 100 are described hereinafter with reference to the example methods illustrated in FIGS. 2-3.

FIG. 2 is a block flow diagram depicting a method 200 for associating a product review with an offer for the product of a merchant.

With reference to FIGS. 1 and 2, in block 205, the review matching system 150 receives an offer URL for a product associated with the merchant system 130. For example, as the merchant system 130 creates offers for the merchant's products, the merchant system 130 creates URLs that are linked to the product offers. By accessing the URL, such as via a browser application (not shown) of the user device 110, a user 101 can view the product and the offer associated with the product. After creating the offer URL, the merchant system 130 may communicate the offer URLs to the review matching system 150, such as via the network 105. The review matching system 150 then receives the offer URL via the network 105.

In certain example embodiments, such as when an operator (not shown) of the merchant system 130 desires to provide the offers on the website of a third-party, the merchant system 130 may communicate the offer URLs to the third-party. For example, the merchant system 130 may communicate the offer URLs to the review matching system 150 via the network 105 so that the review matching system 150 can display the offers, such as on a website 156 associated or affiliated with the review matching system 150. The review matching system 150 then receives the offer URLs via the network 105. Additionally or alternatively, the offer matching system 150 can use a web-crawler, for example, to search and locate offer URLs associated with product offers. For example, the offer matching system 150 can search for offer URLs on a website (not shown) of one or more offer providers such as the merchant system 130.

As used herein, a “product” comprises any tangible or intangible product, and includes any services that a merchant system 130 provides. The offers associated with the product, may be an offer to purchase the product, for example, and may be any type of offer, such as a ticket, coupon, discount, rebate, voucher, loyalty reward, special offer, prepaid offer, or any other type of promotion that can be exchanged for a financial discount or rebate when purchasing a product or service, for example. For online retailers or merchants, for example, the offer for a product may include or be associated with any type of coupon code, promotional or promo code, discount code, key code, reward code, or any other type code exchanged for a financial discount.

The offer URL associated with the product offer may include any content conventionally associated with a URL. For example, the offer URL may include any series of numbers, letters, characters, or combinations thereof that constitute a reference to a resource, such as a link to a website providing a product offer. For example, an offer URL from a particular merchant—when inserted into the address field of a web browser of the user device 110—may direct the user 101 to the website 136 of the particular merchant system 130 where the user 101 can view the product offer. The offer URL may also include content that is unique to the product that is the subject of the offer and/or information that is unique to the merchant 130. For example, an offer for a specific, fixed-gear bicycle from a particular merchant system 130 may include the content “bicyc2397_fgear” in the URL string. In certain example embodiments, the offer URLs may contain multiple path components that are in a specific location within the URL strings. For example, an offer URL for a particular bicycle may contain “bicyc2397” in the first location of the URL string and “fgear” in a separate, second location of the URL string.

In certain example embodiments, a “path component” as used herein may include data, such as organized in hierarchical form, that, along with data in a non-hierarchical query component serves to identify a resource within the scope of a uniform resource identifier (URI) scheme and naming authority (if any). The path may be terminated, for example, by a first question mark (“?”) or number sign (“#”) character, or by the end of the URI. A “path” may include a sequence of path segments separated by a slash (“/”) character. Further, a “query component” may include non-hierarchical data that, along with data in the path component, serves to identify a resource within the scope of the URI's scheme and naming authority (if any). The query component may be indicated, for example, by a first question mark (“?”) character and terminated by a number sign (“#”) character or by the end of the URI. In certain example embodiments, the characters slash (“/”) and question mark (“?”) may represent data within the query component.

In block 210, in addition to receiving an offer URL for a particular merchant system 130, the review matching system 130 receives one or more product review URLs associated with a merchant system 130. For example, a user 101 reviews a product of the merchant system 130, and a review management system 140 affiliated with the merchant system 130 associates the product review with a URL. The review management system 140 then communicates the product-review URL to the review matching system 150, when then receives the product-review URL. The example details of block 210 are described in further detail below with reference to FIG. 3.

FIG. 3 is a block flow diagram depicting a method 210 for receiving a product-review URL, in accordance with certain example embodiments, as referenced in block 210 of FIG. 2.

With reference to FIGS. 1 and 2, in block 305 of method 210, a user 101 receives a product of a merchant, such as from the point-of-sale terminal 134 of the merchant system 130. For example, the user 101 may purchase the product from the point-of-sale terminal 134. Additionally or alternatively, the user 101 may purchase the product from the website 136 of the merchant system 130. The user 101 then receives the product.

In block 310, the user 101 provides a review of the product. For example, after purchasing the product, a user 101 may access the website 136 of the merchant system 130 to provide a review of the purchased product, such as on a user interface (not shown) of the website. In certain example embodiments, when the user 101 accesses the merchant's website 136, the user may be redirected to the website 146 of a review management system 140 that manages reviews for the merchant system 130. Hence, the user 101 may provide the review of the merchant's product via the website 146 of the review management system 130. The review may include any information or content regarding the product, for example, such as information regarding the user's experience with the product or other information conventionally associated with a product review.

In block 315, if the review management system 140 receives the product review, the review management system 140 associates the product review with the product via a URL link to the review. That is, the review management system 140 creates a URL string, that—when inputted into an address filed of a browser—directs the browser to the review of the product. In certain example embodiments, such as when the merchant system 130 receives the product review of the user 101, the merchant system 130 may communicate the review to the review management system 140, which then associates a URL with the review as described herein. In certain example embodiments, the merchant system 130 may associate a URL with the product review.

Like the offer URLs described herein, the product-review URL that the review management system 140 associates with the product review of the user 101 may include any content that is conventionally associated with a URL string, such as any series of numbers, letters, characters, or combinations thereof that constitute a reference to a resource, such as a link to a website providing the product review. The product-review URL may also contain content that is unique to the product, content that is unique to the review for the product, and content that is unique to the merchant 130 offering the product. For example, a product review for a specific, fixed-gear bicycle from a particular merchant system 130 may include the content “bicyc2397_fgear” in the URL string. In certain example embodiments, the product-review URLs may contain multiple path components that are in a specific location within the URL strings. For example, a product-review URL for a particular bicycle may contain “bicyc2397” in the first location of the URL string and “fgear” in a separate, second location of the URL string.

In block 320, the review management system 140 communicates product-review URL to the review matching system 150. That is, after associating a user's product review with a product-review URL for the review, the review management system 140 transmits the product-review URL and associated review to the review matching system 150, such as via the network 105. The review matching system 150 then receives the product-review URL from the review management system 140. In certain example embodiments, such as when the merchant system 130 associates the user's product review with the URL as described herein, the merchant system 130 may transmit the product-review URL and associated review to the review matching system 150. The review matching system 150 then receives the product-review URL, for example, from the merchant system 130.

Returning to FIG. 2, in block 215 of FIG. 2, the review matching system 150 determines the content of the offer URL and one or more product-review URLs. That is, the review matching system 150 reads the offer URL and product-review URLs to determine the numbers, letters, characters, or combinations thereof in the path strings of the URLs. In certain example embodiments, the review matching system 150 may associate the determined content of the offer URL and the one or more product-review URLs with the data storage unit 157, such as in a record for product-review URLs. Additionally or alternatively, the review matching system 150 may associate the content with a merchant account (not shown) that may be associated with the review matching system 150.

In block 220, the review matching system 150 identifies a content match between the offer URL and the one or more product review URLs. That is, based on the determined content of the received offer URL and the one or more product-review URLs, the review matching system 150 determines numbers, letters, characters, or combinations thereof that are the same are similar among the offer URL and a product-review URL. For example, if both a received offer URL and a product-review URL include the content “bicyc2397_fgear,” the review matching system 150 determines that “bicyc2397_fgear” is a content match for the offer URL and product-review URL. In certain example embodiments, the content match may be in different locations in the offer URL and the product-review URL. For example, an offer URL and a product-review URL for a particular bicycle may both contain the content “bicyc2397_fgear.” The matching content “bicyc2397_fgear” may appear in the offer URL at the 40^{th} character, while the matching content “bicyc2397_fgear” may appear in the product-review URL at the 50^{th} character.

In certain example embodiments described herein, an offer URL and a product-review URL may include multiple, matching path components that are in a specific location within the URL strings. For example, an offer URL and a product-review URL for a particular bicycle may contain “bicyc2397” in the first location of the URL strings and “fgear” in a separate, second location of the URL strings. In certain example embodiments, the first and second locations may be similarly located with the URL strings. For example, in both an offer URL and a product-review URL, the matching “bicyc2397” and “fgear” content may be separated by a similar number of characters within the offer URL and product-review URL strings. Alternatively, the first and second locations may be spaced differently within the URL strings. For example, the matching “bicyc2397” and “fgear” content may be separated by 30 numbers and characters in the offer URL, whereas the matching “bicyc2397” and “fgear” content may be separated by 15 characters in the product-review URL.

In another example embodiment, the content match may include a single component in one URL and separate components in the other URL. For example, the offer URL may include the content “bicyc2397_fgear” in the offer URL string, whereas the product-review URL includes the content “bicyc2397” and “fgear” in different locations within the product-review URL string. The review matching system 150, however, may nevertheless determine that the “bicyc2397” and “fgear” content present in both the offer URL string and the product-review URL string is the content match.

In certain example embodiments, the review matching system 150 may rely on a rule template for identifying and extracting content matches from the received offer URLs and product-review URLs. For example, each rule of the template may be for a specific field name of an offer or review, such as “offer_url.” A content match may either be a path component of the URL (as specified by a component index of the URL), or the entire content of certain fields (such as “offer_id”). Optionally, a rule may also contain a number of conditions that the field must meet. For example, the field may include a specific URL hostname and/or have a specific number of path components, such as two or more path components. Additionally or alternatively, the field may include a specific set of path components in specific locations.

In certain example embodiments, the review matching system 150 may rely on the rule template to enumerate all possible content matches and extraction rules. The review matching system 150 may then determine the quality of the content match based on co-occurrence statistics and the quality of the extraction rules based on the quality of the content matches they extract. For example, the review matching system 150 may apply the following rules for a given a set of offers, O, and a set of reviews, V:
1) For each offer o in O :
   a. Enumerate all possible content matches, mₒ, extractable from o, along with the rules, rₒ, that extract them.
   b. If rₒ extracts mₒ from a URL, u:
      i. Add the hostname of u, and the number of path components in u, to rₒ as rule conditions.
      ii. For each path component c in u, add c to rₒ as a rule condition, if the frequency of c relative to the number of offers from the merchant is above a threshold, t_{c} =0.1, for example.
   c. Add all resulting (mₒ, rₒ) to the set Mₒ.
2) For each review v in V, repeat the above rule (1) to generate an output set Mᵥ:
3) For each content m in Mₒ U Mᵥ:
   a. Count the number of times in which m is extractable from each offer/review field, and form a histogram, Hₘ=[(f₁, n₁), (f₂, n₂), . . . ], where f₁ are unique offer/review fields.
   b. m is determined to be a “good” content if:
      i.Hₘ contains both offer and review fields from the same merchant; and,
      ii. The relative frequency nᵢ I N, where N is the number of offers or review from the same merchant, is below the threshold, tₘ=0.001, for example, for all i.
4) For each rule r in Mₒ u Mᵥ:
   a. Count the number of times in which r extracts “good” content versus “bad” content.
   b. r is considered a “good” content rule if the ratio of ^{“}good” extracted content matches is above the threshold, tᵣ=0.1, for example.

In certain example embodiments, the notion of a “good” or “bad” content according to the above example rules may be rough. For example, there is an unknown ground truth about whether an offer associated with an offer URL has matching reviews. If the ground truth is such that the offer does not have any reviews, then no rule is available to match the offer to any reviews. Hence, all learned rules that apply to the offer would thus necessarily have “bad” content—the rule may extract content, but no matching review for the offer. As such, the review matching system 150 may, in certain example embodiments, have “bad” content because product offers exist for which there is no review.

If the review matching system 150 identifies a content match between the received offer URL and the product-review URL, the method follows the “YES” branch of block 225 to block 235, in accordance with certain example embodiments. If the review matching system 150 does not identify a content match between the received offer URL and the product-review URL, the method follows the “NO” branch of block 225 to block 230, in accordance with certain example embodiments.

In block 230, the review matching system 150 determines that the offer URL is not associated with the product review URL. That is, if the review matching system 150 does not identify a content match between the offer URL and the product-review URL, the review matching system 150 determines that the review associated with the product-review URL does not relate to the subject matter of the offer associated with the offer URL. Hence, based on the absence of a content match, the review matching system 150 does not associate the product review (associated with the product-review URL) with the product that is the subject of the offer (that is associated with the offer URL).

In block 235, the review matching system 150 determines that the product-review URL is associated with the offer URL. That is, based on the identification of content match between the offer URL and the product-review URL, the review matching system 150 determines that the offer URL and the product-review URL relate to each other. For example, if the content match includes “bicyc2397_fgear” in the URL strings of the offer URL and the product-review URL, the review matching system 150 determines that the offer URL and the product-review URL are related to each other based on the “bicyc2397_fgear” content match.

In block 240, the review matching system 150 determines that the review associated with product-review URL corresponds to the product associated with the offer URL. That is, the review matching system 150 determines that the user's product review—that is associated with the product-review URL—is a review for the product associated with the offer URL. For example, a review for a particular bicycle of a merchant 130 may be associated with a URL that includes “bicyc2397_fgear” in the URL string. If the review matching system 150 receives the product-review URL with the “bicyc2397_fgear” content—and then identifies an offer URL including the same “bicyc2397_fgear” content—the review matching system 150 determines that a content match exists. Hence, the review matching system 150 determines that the user's review (associated with the product-review URL) can be matched to the product that is associated with the offer URL.

In block 245, the review matching system optionally associates multiple product reviews for a product with an offer for the product. That is, in certain example embodiments, the review matching system 150 may—based on the methods and system described herein—match several product reviews to the product that is the subject of the review. The review matching system 150 may also maintain a record (not shown) of reviews that are associated with a particular product.

For example, if the review matching system 150 matches a user review of a specific bicycle to a bicycle that a particular merchant 130 offers for sale, the review matching system 150 may associate the user's review with the bicycle in the record. The review matching system 150 may also match a second user review to the same bicycle, based on the content of a product-review URL and an offer URL from a different merchant, for example. Hence, the review matching system 150 can then associate the second review—of the particular bicycle—with the record of reviews for the particular bicycle. By accessing the record, the review matching system 150 can associated multiple reviews of the particular bicycle with the particular bicycle.

In certain example embodiments, the review matching system 150 may provide an offer for the product, such as on a website 156 affiliated with the review matching system 150. In which case, the review matching system 150 can provide all reviews that the review matching system 150 has on record for the product. For example, if the review matching system 150 has matched multiple reviews to the particular bicycle in the above example—the reviews being from different users 101 who may have purchased the bicycle from an assortment of merchants 130—the review matching system 150 can associate all matched reviews with an offer for the particular bicycle when offering the bicycle for sale. A user 101 seeking to purchase a bicycle of on the website 156, for example, can then examine multiple reviews when researching the particular bicycle.

### Other Example Embodiments

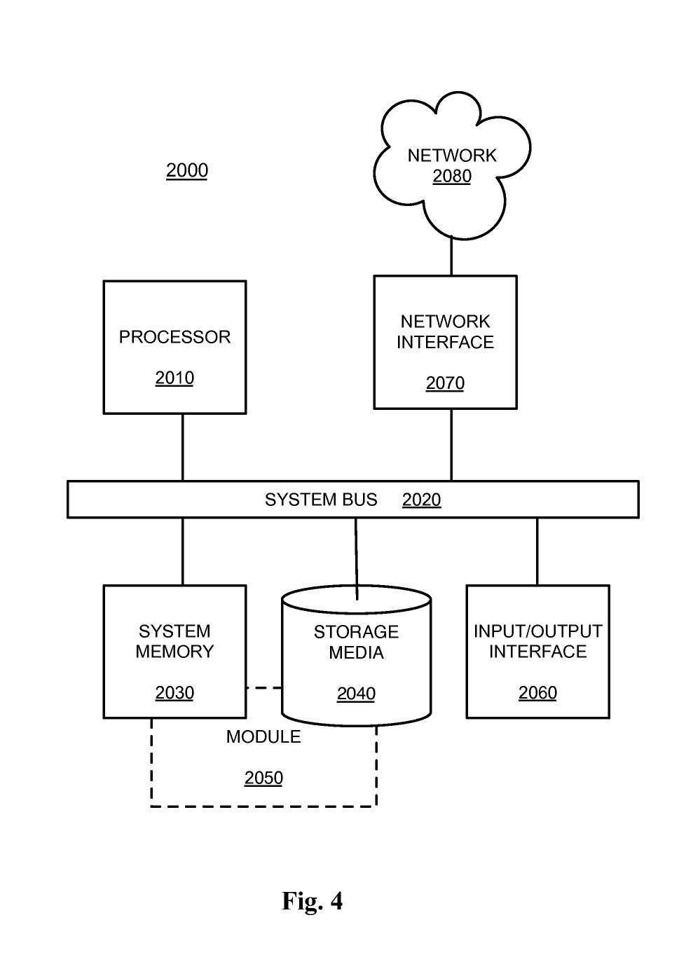

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain example embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the examples described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer implemented method to match product reviews to product offers, comprising:
receiving, by one or more computing devices of a review matching system, a first Uniform Resource Locator (URL), wherein the first URL is associated with a product review not associated by the one or more computing devices with a product of a merchant;
receiving, by the one or more computing devices, a second URL, wherein the second URL is associated with an offer for a product of the merchant;
identifying, by the one or more computing devices, a match between a first pattern among fields of the first URL and a second pattern among fields of the second URL;
in response to identifying the match, determining, by the one or more computing devices, that the product review associated with the first URL is a review of the product in the offer of the merchant associated with the second URL; and
associating, by the one or more merchant computing devices, the product review with the product.

2. The method of claim 1, wherein identifying a match between the first pattern among fields of the first URL and the second pattern among fields of the second URL comprises
identifying, by the one or more computing devices, at least one of: a specific number of path components, or a specific set of at least one path component in specific locations in the URLs.

3. (canceled)

4. (canceled)

5. (canceled)

6. (canceled)

7. (canceled)

8. A system to match product reviews to product offers, comprising:
a storage device;
a processor communicatively coupled to the storage device, wherein the processor executes application code instructions that are stored in the storage device to cause the system to:
receive a first Uniform Resource Locator (URL), wherein the first URL is associated with a product review of a user not associated by the one or more computing devices with a product of a merchant;
receive a second URL, wherein the second URL is associated with an offer for a product of the merchant;
identify a match between a first pattern among fields of the first URL and a second pattern among fields of the second URL; and
determine, in response to identifying the match, that the product review associated with the first URL is a review of the product in the offer of the merchant associated with the second URL.

9. The system of claim 8, further comprising associating the product review with the product in response to determining that the product review associated with the first URL is a review of the product in the offer of the merchant associated with the second URL.

10. The system of claim 9, wherein identifying a match between the first pattern among fields of the first URL and the second pattern among fields of the second URL comprises
identifying at least one of: a specific number of path components, or a specific set of at least one path component in specific locations in the URLs.

11. (canceled).

12. (canceled)

13. (canceled)

14. (canceled)

15. A computer program product, comprising:
a non-transitory computer-readable storage device having computer-executable program instructions embodied thereon that when executed by a computer cause the computer to match product reviews to product offers, the computer-executable program instructions comprising:
computer-executable program instructions to receive a first Uniform Resource Locator (URL), wherein the first URL is associated with a product review of a user not associated by the one or more computing devices with a product of a merchant;
computer-executable program instructions to receive a second URL, wherein the second URL is associated with an offer for a product of the merchant;
computer-executable program instructions to identify a match between a first pattern among fields of the first URL and a second pattern among fields of the second URL; and
computer-executable program instructions to determine, in response to identifying the match, that the product review associated with the first URL is a review of the product in the offer of the merchant associated with the second URL.

16. The computer program product of claim 15, further comprising computer-executable program instructions to associate the product review with the product in response to determining that the product review associated with the first URL is a review of the product in the offer of the merchant associated with the second URL.

17. The computer program product of claim 15, wherein identifying a match between the first pattern among fields of the first URL and the second pattern among fields of the second URL comprises
identifying at least one of: a specific number of path components, or a specific set of at least one path component in specific locations in the URLs.

18. (canceled)

19. (canceled)

20. (canceled)
